(19) United States
(12) Patent Application Publication
(10) Pub. No.: US 2012/0046426 A1
(43) Pub. Date: Feb. 23, 2012

(54) OLEFIN POLYMERIZATION PROCESS WITH REDUCED FOULING

(76) Inventor: Xinggao Fang, Richmond, VA (US)

(21) Appl. No.: 13/265,057

(22) PCT Filed: Apr. 27, 2010
(86) PCT No.: PCT/US10/32481

§ 371 Date: Oct. 18, 2011

Related U.S. Application Data
(60) Provisional application No. 61/178,571, filed on May 15, 2009.

(51) Int. Cl. C08F 2/34; C08F 10/06; C08F 10/02; C08F 2/12

(52) U.S. Cl. 526/74

(57) ABSTRACT

The invention concerns methods for polymerization of olefins comprising contacting one or more monomers selected from ethylene and α-olefins with a supported single site catalyst in the presence of one or more magnesium alkyl compounds wherein said magnesium alkyl is present during the major portion of said polymerization.

### TECHNICAL FIELD

The present invention concerns use of magnesium alkyls to reduce reactor fouling during olefin polymerization.

### BACKGROUND

Polyolefins are commonly prepared by reacting olefin monomers in the presence of catalysts composed of a support and catalytic metals deposited on the surfaces of the support. Transition metals, and especially titanium and zirconium, are known choices for the metal. Small amounts of water and other polar impurities can negatively affect olefin polymerization. Aluminum alkyls, such as triethyl aluminum and triisobutyl aluminum, are often utilized in olefin polymerization to scavenger poisonous materials such as water and other polar agents. Use of these compounds, however, can have a negative consequence in that they can cause reactor fouling. Such fouling can be particularly pronounced in gas phase and slurry phased olefin polymerizations.

Extensive work has been devoted to reduce or eliminate reactor fouling. Strategies to reduce such fouling include (a) removing scavengers before polymerization starts, or before it is substantially completed, (b) chemically linking the catalyst to a support, or (c) using an ultrasonic process to drive co-activator and catalyst into the support. In other techniques, metallocene catalysts on solid supports have been used to reduce reactor fouling. While these techniques have some effect, significant fouling can still result. Thus, there is a need in the art for processes that can cost-effectively eliminate or reduce reactor fouling.

### SUMMARY

In one aspect, the invention concerns methods for polymerization of olefins comprising contacting one or more monomers selected from ethylene and a-olefins with a supported single site catalyst in the presence of one or more compounds of the formula MgR¹R² wherein R¹ is alkyl, aryl, arylalkyl, O-alkyl, O-aryl, or O-alkylaryl; R² is alkyl, aryl, arylalkyl; and MgR¹R² is present during the major portion of the polymerization. The MgR¹R² is preferably present substantially throughout the polymerization.

Suitable compounds of the formula MgR¹R² include magnesium alkyls. Examples of magnesium alkyls are compounds where R¹ and R² are each, independently, C₁-C₁₂ alkyl or C₁-C₁₂ hydrocarbyloxy, provided that at least one of R¹ and R² are alkyl. Dialkyl magnesium compounds (such as di-n-butylmagnesium) are preferred in some embodiments. The MgR¹R² compound can be present in any amount that provides the desired reduction in reactor fouling. In some embodiments, the amount of magnesium alkyl is at least 100 ppm based on the combined weight of the catalyst, MgR¹R², and reaction medium.

Preferred catalysts for the polymerization reactions described herein are single site catalysts, such as metallocene catalysts. Typically, a metallocene catalyst comprises a transition metal in coordination with members of at least one five-member carbon ring, hetero-substituted aromatic ring, or a bridged (ansa) ligand. A hetero-substituted five carbon ring is one example of such a member.

The methods described herein are generally applicable to solution-phase, gas-phase, and slurry-phase polymerization of ethylene and a-olefins to form, for example, polyethylene (optionally including residues of a-olefin comonomers such as 1-butene, 1-hexene and 1-octene), polypropylene, and various co-polymers of these. Preferred polymerization and co-polymerization reactions include those in which at least about 50 mole percent of the monomer is ethylene, and/or those including propylene monomer. As used herein, and unless otherwise indicated from the context, “polymerization” includes co-polymerization.

Of the various polymerization reactions contemplated herein, gas-phase and or slurry-phase reactions are more susceptible to fouling. Accordingly, the invention is also directed to methods of gas-phase or slurry-phase polymerization of olefins with reduced reactor fouling.

Yet another aspect of the invention concerns methods for polymerization of olefins comprising: (a) contacting monomers selected from ethylene, a-olefins, and mixtures of these with a supported single site catalyst and one or more magnesium alkyl compounds; and (b) polymerizing the monomers without actively removing a substantial amount of the magnesium alkyl.

### DETAILED DESCRIPTION OF ILLUSTRATIVE EMBODIMENTS

The invention concerns methods for polymerization of olefins comprising contacting one or more monomers selected from ethylene and α-olefins with a supported single site catalyst in the presence of one or more compounds of the formula MgR¹R² wherein R¹ is alkyl, aryl, arylalkyl, —O-alkyl, —O-aryl, or —O-alkylaryl; R² is alkyl, aryl, arylalkyl; and MgR¹R² is present during the major portion of the polymerization and is preferably present substantially throughout the polymerization. Use of these methods can advantageously reduce the amount of reactor fouling during polymerization.

Any MgR¹R² compound that provides reduced reactor fouling can be utilized in the present invention. Examples of such compounds are those where R¹ and R² are each, independently, C₁-C₁₂ alkyl or C₁-C₁₂ hydrocarbyloxy, provided that at least one of R¹ and R² are alkyl. In some compounds R¹ and R², are identical alkyl groups. The alkyl groups may be substituted so long as the substation does not negatively impact the polymerization reaction. Some alkyl groups, for example, may be substituted with an aryl group. One particularly preferred magnesium alkyl is di-n-butylmagnesium which is available commercially from Aldrich.

The amount of MgR¹R² compound that is utilized in the reaction can vary depending on the type of catalyst and polymerization processes utilized. In some embodiments, the amount of magnesium alkyl is at least about 20 ppm based on the combined weight of the catalyst, MgR¹R², and reaction medium. Certain embodiments of the invention use about 20 to about 10,000 ppm, preferably from about 50 to about 1000 ppm, most preferred from about 50 to about 500 ppm of MgR¹R² compound based on the combined weight of the catalyst, MgR¹R², and reaction medium.

Any single site olefin polymerization catalyst known in the art can be utilized in the present invention. Both early and late transition metal complexes are available. Useful metal complexes include those of titanium, zirconium, hafnium, chromium, iron, and nickel. Certain catalysts comprise a transition metal on the surface of a support. Supports include inorganic oxides such as SiO₂, Al₂O₃, MgO, AlPO₄, TiO₂, ZrO₂, Cr₂O₃, and mixtures thereof. Other supports include carbon black, polyethylene, and polystyrene. In some embodiments, preferred supports include silica supports. Such supports include those described in U.S. Pat. Nos. 6, 313, 061, 7,005,400 and 6,946,420, the disclosures of which is incorporated by reference herein in its entirety. The transition metal(s) can be applied to the support in manners well known to those skilled in this art. For example, a catalyst precursor, an activator, and a solvent can be contacted with a catalyst support and the catalyst formed by removal of the solvent.

Preferred single site catalysts include metallocene catalysts. Typically, metallocene catalyst comprise a transition metal in coordination with members of at least one five-member carbon ring, hetero-substituted aromatic ring, or a bridged (ansa) ligand. A hetero-substituted five carbon ring is one example of such a member.

The following terms, used in the present description and the appended claims, have the following definitions:

“Single-site catalyst” refers to a catalyst which contains one or more ancillary ligands that influence the stearic and/or electronic characteristics of the polymerizing site so as to prevent formation of secondary polymerizing species. Single site catalysts can be used in the present invention include those found in Chem. Rev. 2000, 100, 1167-1682. Typical single site catalyst comprise a complex having an activator and a supported transition metal complex containing at least one polymerization-stable ligand bonded to the transition metal. Metallocene catalyst are one preferred single site catalyst.

“Metallocene” catalysts are commonly understood to mean organometallic compounds having a transition metal, including rare earth metals, in coordination with members of at least one five-member carbon ring, hetero-substituted aryl (such as a hetero-substituted five-member carbon ring), or a bridged (ansa) ligand defined as two cyclic moieties capable of coordinating to the transition or rare earth metals wherein the ansa bridge B can be carbon, boron, silicon, phosphorus, sulfur, oxygen, nitrogen, germanium, species such as CH₂CH₂ (ethylene), Me₂Si (dimethylsilyl), Ph₂Si(diphenylsilyl) Me₂C(isopropylidene), Ph₂P(diphenylphosphoryl) Me₂SiSiMe₂ (tetramethyldisilane) and the like. In particular, preferred metallocenes are derivatives of a cyclopentadiene(Cp), including cyclopentadienyl, substituted cyclopentadienyls, indenyl, fluorenyl, tetrahydroindenyl, phosphocyclopentadienes, 1-metallocyclopenta-2,4-dienes, bis(indenyl)ethane, and mixtures thereof Metallocene catalyst is typically activated by combining the active metal species with boranes, borates, or aluminoxane compounds well known in the art.

The transition metal component of the metallocene can be selected from Groups IIIB through Group VIII of the Periodic Table and mixtures thereof, preferably Group IIIB, IVB, VB, VIB, and rare earth (i.e., lanthanides and actinides) metals, and most preferably titanium, zirconium, hafnium, chromium, vanadium, samarium, and neodymium. Of these, Ti, Zr, and Hf are most preferable.

The term “transition metal” as used herein generally refers to Groups IIIA through VIII of the periodic table (IUPAC). Suitable transition metals include Ni, Fe, Ti, Mn, Zr, Cr, Hf, Pd, and mixtures thereof Transition metals can be in various oxidation states.

The term “alkyl” is used herein to refer to both linear and branched hydrocarbon groups. These hydrocarbon groups can be saturated and unsaturated. Alkyl groups have at least one carbon atom and, in some embodiments, 1 to 12 or 1 to 6 carbon atoms. Alkyl groups can be optionally substituted with substituents that do not negatively impact the olefin polymerization reaction.

The term “aryl”, as used herein, is an aromatic carbocyclic moiety of up to 20 carbon atoms, (e.g. 6-20 carbon atoms), which may be a single ring (monocyclic) or multiple rings (e.g. bicyclic) fused together or linked covalently. Any suitable ring position of the aryl moiety may be covalently linked to the defined chemical structure. Examples of aryl moieties include, but are not limited to, chemical groups such as phenyl, 1-naphthyl, 2-naphthyl, dihydronaphthyl, tetrahydronaphthyl, biphenyl, anthryl, phenanthryl, fluorenyl, indanyl, biphenylenyl, acenaphthenyl, acenaphthylenyl, and the like. It is preferred that the aryl moiety contain 6-14 carbon atoms.

The term “arylalkyl”, as used herein, is a C₆-C₂₀ aryl suitably substituted on any open ring position with an alkyl moiety wherein the alkyl chain is either a (C₁₋₇) straight or (C₃-C₇) branched-chain saturated hydrocarbon moiety. Examples of aryl(C₁-C₇)alkyl moieties include, but are not limited to, chemical groups such as benzyl, 1-phenylethyl, 2-phenylethyl, diphenylmethyl, 3-phenylpropyl, 2-phenylpropyl, fluorenylmethyl, and homologs, isomers, and the like. A group, such as a benzyl group, may be bound to the chemical structure through the methylene group.

The term “hydrocarbyloxy” refers to an —O-R group where R is alkyl, aryl, or arylalkyl. Preferred hydrocarbyloxy groups include alkoxy where R is C₁-C₁₂ alkyl.

“Reactor fouling” refers to a build up of films or other unwanted agglomerates within the reactor that negatively impact polymerization performance and/or the build up of polymer deposits on the inner surfaces of the reactor.

“Major portion” refers to more than one half (for example, more than one half of the amount of monomer, percent polymerization, or the like).

The term “substantially all,” in reference to the polymerization, refers to at least 90% and preferably at least 95% of the total amount (such as the degree of polymerization).

As used herein, the term “magnesium alkyl” includes compounds having two alkyl groups coordinated with the magnesium as well as compounds having one alkyl and one hydrocarbyloxy group coordinated to magnesium.

The catalyst systems of the present invention can be used for polymerizing one or more monomers in the presence of a catalyst described herein. Preferred monomers include ethylene and α-olefins. Examples of such monomers include mono-olefins containing 2 to 8 carbon atoms per molecule such as ethylene, propylene, 1-butene, 1-pentene, 1-hexene, and 1-octene. Preferred polymers include polyethylene homopolymers and copolymers of ethylene and mono-olefins containing 3 to 8 carbon atoms per molecules.

Catalyst system components described herein are useful to produce polymers using solution polymerization, slurry polymerization, or gas phase polymerization techniques. As used herein, the term polymerization includes copolymerization and terpolymerization, and the terms olefins and olefinic monomers include olefins, alpha-olefins, diolefins, styrenic monomers, acetylenically unsaturated monomers, cyclic olefins, and mixtures thereof. The catalysts described herein also may be used to produce ethylene polymers in a particle-form process as disclosed in U.S. Pat. Nos. 3,624,063, 5,565,175, and 6,239,235, which are incorporated by reference herein in their entirety. The instant catalysts are particularly useful for gas phase and slurry phase polymerizations.

Methods and apparatus for effecting such polymerization reactions are well known. The catalysts used in the present invention can be used in similar amounts and under similar conditions known to those skilled in the art of olefin polymerization. Typically for the slurry process, the temperature is from approximately 0° C. to just below the temperature at which the polymer becomes soluble in the polymerization medium. For the gas phase process, the temperature is from approximately 0° C. to just below the melting point of the polymer. For the solution process, the temperature is typically the temperature from which the polymer is soluble in the reaction medium, up to approximately 275° C.

The pressure used in the polymerization reaction is not critical and can be from sub-atmospheric to about 20,000 psi. One preferred pressure range is from atmospheric to about 1000 psi, and most preferred from 50 to 550 psi. In the slurry or particle form process, the process is suitably performed with a liquid inert diluent such as a saturated aliphatic hydrocarbon. The hydrocarbon is typically a C₄ to C₁₀ hydrocarbon, e.g., isobutane, hexane and heptane. Polymer recovery methods are also well known and depend on the kind of polymerization reaction. The polymer is recovered directly from the gas phase process; by removal of diluent , by filtration or evaporation, in the slurry process; or by evaporation of solvent in the solution process.

Slurry reactors can comprise vertical loops or horizontal loops. Gas-phase reactors can comprise fluidized bed reactors or tubular reactors. Solution reactors can comprise stirred tank or autoclave reactors. In some embodiments, such reactors can be combined into multiple reactor systems operated in parallel or in series. Suitable equipment for particle-form processes is disclosed in U.S. Pat. Nos. 3,624,063, 5,565,175, and 6,239,235.

Depending on the process used, the amount of catalyst present in the reaction zone may range from about 0.001% to about 1% by weight of all materials in the reaction zone.

In one embodiment, a slurry polymerization process is employed in which the catalyst is suspended in an inert organic medium and agitated to maintain it in suspension throughout the polymerization process. The organic medium may, e.g., be a paraffin, a cycloparaffin, or an aromatic. For the production of ethylene polymers, the slurry polymerization process may be carried out in a reaction zone at a temperature of from about 50° C. to about 110° C. and at a pressure in the range of from about 100 psi to about 700 psi or higher. At least one monomer is placed in the liquid phase of the slurry in which the catalyst is suspended, thus providing for contact between the monomer and the catalyst. The activity and the productivity of the catalyst are relatively high. As used herein, the activity refers to the grams of polymer produced per gram of solid catalyst charged per hour, and the productivity refers to the grams of polymer produced per gram of solid catalyst charged.

In the processes described herein, hydrogen gas can be introduced into the reaction zone where desired to reduce the molecular weight of the polymers formed.

The following examples are given as specific illustration of the claimed invention. It should be understood, however, that the invention is not limited to the specific details set forth in the examples. All parts and percentages in the examples and in the remainder of the specification are by weight unless otherwise specified.

Further, any range of numbers recited in the specification or claims, such as representing a particular set of properties, units of measure, conditions, physical states or percentages, is intended to literally incorporate expressly herein by reference or otherwise, any number falling within such range, including any subset of numbers within any range so recited.

### EXAMPLES

### General Experimental

Unless otherwise specified, all operations were run under inert atmosphere such as a glove box.

Bench scale reactor polymerization (BSR) was carried out in a 2L Zipperclave reactor from Autoclave Engineer. The reactor is remotely controlled via a desktop computer that is running Wonderware's version 7.1 software program. Materials were handled and preloaded in a Vacuum Atmosphere glove box. The reactor body is prepared by preheating the unit to the desired internal temperature. Temperature control of the reactor is maintained by a Neslab RTE-111 heating/cooling bath. To make the unit's atmosphere inert and to aid in the drying of the internal parts the equipment is placed under vacuum. The vacuum is generated by means of an Edward's E2M8 vacuum pump. To start a polymerization test heptane, hexene, and cocatalyst (i.e., scavenger) are loaded into a pressure/vacuum rated glass “Pop” bottle inside of the glovebox so no air or moisture are introduced into the reactor. This mixture is removed from the drybox and then transferred into the test unit utilizing the reactor's internal vacuum to suck the solution into the reactor. The reactor's double helical stirrer is started and the computer program is initiated to begin controlling the water bath so the desired internal temperature is maintained. While the temperature restabilizes a 75 ml metal Hoke bomb is loaded inside the glovebox with a slurry of the desired catalyst loading and 20 ml heptane. This container is removed from the glovebox and connected to the injection port by using an external supply of Argon to prepurge all piping connections. The desired levels of ethylene and hydrogen gases are then introduced into the reaction vessel using the computer to add and monitor the unit pressure. The catalyst/heptane slurry is blown into the reactor using the high pressure argon gas supply. The software program is then set to control the final reaction pressure by remotely adding more ethylene gas to maintain a constant internal pressure. The typical test lasts for one hour from this point. When the polymerization test is finished the gas supply is shut off, the Neslab bath is shut off, and cooling water is introduced to the reactor jacket. Once the internal temperature has dropped below 50° C. the stirrer is stopped, all gases are vented from the unit, and the cooling water is stopped. The reactor body is then opened to remove the polyethylene product. The internal reactor wall and stirrer are then cleaned. The unit is resealed and pressurized with Argon gas to ensure no leaks are present in the system. Once the unit has passed this pressure test the Argon is vented, the reactor is placed back under vacuum, and reheated via the Neslab bath to prepare for the next test cycle.

The fouling metric used to report reactor fouling is presented in Table 1.

TABLE 1

| Metric | Observation |
|---|---|
| 0 | no fouling, reactor clean, no noticeable sheeting on reactor wall. |
| 1 | minimal fouling, a little sheeting (visually less than 5% area) |
| | on reactor wall or agitator. |
| 2 | intermediate fouling, very noticeable sheeting (visually 5-20%) |
| | on reactor wall or agitator. |
| 3 | sever fouling, significant sheeting (visually over 20% area) |

Melt Index (MI) and high load melt index (HLMI) are measured according to ASTM method D1238-04. Melt flow ratio (MFR) is defined as HLMI/MI. Apparent bulk density (ABD) is measured according to ASMT method D1895.

Activity is determined by dividing (i) the yield of the product (grams) by (ii) the amount of catalyst used in the reaction (grams) times reaction time (hours); i.e., activity=yield/(catalyst×time).

The terms “scavenger” and “cocatalyst” are used interchangeably herein. Such use is consistent with the possible dual role of the additive.

### Example 1

A Hf based catalyst was prepared generally following the method disclosed in EP1462464A1. BSR conditions, as described above, were 224 psi ethylene, 350 mL heptane, 15 mL 1-hexene, 1 mmol of scavenger (or cocatalyst), 80° C. for 1 hour. Polymerization results listed in Table 2. NM indicates that the value was not measured.

TABLE 2

| | | Activity | | | Fouling |
|---|---|---|---|---|---|
| Run # | cocatalyst | (g/g-hr) | ABD | HLMI | Metric |
| A | TiBAl | 1302 | 0.438 | 1.19 | 0 |
| B | Bu₂Mg | 1728 | 0.444 | 1.31 | 0 |
| C | Et₃B | 876 | 0.391 | 0.48 | 1 |
| D | Et₂Zn | 469 | NM | 7.23 | 0 |
| E | TEAl | 703 | 0.423 | 0.95 | 0 |

### Example 2

A Ti based catalyst was generally prepared by the method disclosed US20050255988A1. BSR conditions, as described above, were 224 psi ethylene, 350 mL hetpane, 2.0 mmol of M-R scavenger, 70° C. for 1 hour. Polymerization results are presented in Table 3.

TABLE 3

| Run # | Catalyst | Activity(g/g-hr) | ABD | fouling |
|---|---|---|---|---|
| F | TiBAL | 175 | | 3 |
| G | Bu₂Mg | 1313 | 0.304 | 0 |
| H | Bu₂Mg | 1274 | 0.302 | 0 |

### Example 3

The catalyst utilized was (nBu-Cp)₂ZrCl₂ and methylaluminoxane supported on silica. See, PCT Patent Application No. 2006/130953. BSR conditions were 224 psi ethylene, 10 mL 1-hexene, 350 mL hetpane, 80° C. for 1 hour. Neither reaction produced visible reactor fouling. Results are presented in Table 4.

TABLE 4

| scavenger | Activity(g/g-hr) | ABD(g/cc) | MI | HLMI | MFR |
|---|---|---|---|---|---|
| 0.50 mmol | 3929 | 0.301 | 1.78 | 31.15 | 17.5 |
| Bu₂Mg | | | | | |
| scavenger | | | | | |
| 0.35 mmol | 3898 | 0.352 | 1.87 | 32.74 | 17.51 |
| TiBAL | | | | | |

What is claimed:

1. A method for polymerization of olefins comprising contacting monomers selected from ethylene, a-olefins, and mixtures of these with a supported single site catalyst in the presence of one or more compounds of the formula MgR¹R² wherein
R¹ is alkyl, aryl, arylalkyl, —O-alkyl, —O-aryl, or —O-alkylaryl;
R² is alkyl, aryl, arylalkyl;
and said MgR¹R² is present during the major portion of said polymerization.

2. The method of claim 1, wherein said MgR¹R² is present substantially throughout said polymerization.

3. The method of claim 1, wherein R¹ and R² are each, independently, C₁-C₁₂ alkyl.

4. The method of claim 3, wherein at least one C₁-C₁₂ alkyl group is substituted with an aryl group.

5. The method of claim 3, wherein said MgR¹R² is di-n-butylmagnesium.

6. The method of claim 1, wherein said single site catalyst is a metallocene catalyst.

7. The method of claim 6, wherein said metallocene catalyst comprises a transition metal in coordination with members of at least one five-member carbon ring, hetero-substituted aromatic ring, or a bridged (ansa) ligand.

8. The method of claim 1, wherein said polymerization is performed in the gas phase.

9. The method of claim 1, wherein said polymerization is a slurry phase polymerization.

10. The method of claim 1, wherein at least about 50 mole percent of said monomer is ethylene.

11. The method of claim 1, wherein said monomer comprises propylene.

12. A method of reducing reactor fouling in gas phase or slurry phase olefin polymerization reactors, said method comprising contacting monomers selected from ethylene, α-olefins, and mixtures of these with a supported single-site catalyst in the presence of one or more compounds of the formula MgR¹R² wherein
R¹ is alkyl, aryl, arylalkyl, —O-alkyl, —O-aryl, or —O-alkylaryl;
R² is alkyl, aryl, arylalkyl;
and said MgR¹R² is present during the major portion of said polymerization.

13. The method of claim 12, wherein said MgR¹R² is present substantially throughout said polymerization.

14. The method of claim 12, wherein R¹ and R² are each, independently, C₁-C₁₂ alkyl.

15. The method of claim 12, wherein MgR¹R² is di-n-butylmagnesium.

16. The method of claim 12, wherein said single site catalyst is a metallocene catalyst.

17. The method of claim 12, wherein at least about 50 mole percent of said monomer is ethylene.

18. The method of claim 12, wherein said monomer comprises propylene.

19. The method of claim 12, wherein the reactor has less fouling than if a substantial portion of said magnesium alkyl were removed prior to or during said polymerization.

20. A method for polymerization of olefins comprising:
(a) contacting monomers selected from ethylene, α-olefins, and mixtures of these with a supported single site catalyst and one or more compounds of the formula MgR¹R² wherein
R¹ is alkyl, aryl, arylalkyl, —O-alkyl, —O-aryl, or —O-alkylaryl;
R² is alkyl, aryl, arylalkyl; and
(b) polymerizing said monomers without actively removing a substantial amount of said magnesium alkyl prior to or during said polymerization.

21. The method of claim 20, wherein R¹ and R² are each, independently, C₁-C₁₂ alkyl.

22. The method of claim 20, wherein said MgR¹R² is di-n-butylmagnesium.

23. The method of claim 20, wherein said single site catalyst is a metallocene catalyst

24. The method of claim 20, wherein said polymerizing is performed in a gas phase.

25. The method of claim 20, wherein said polymerizing is performed in a slurry phase.
